(19) United States
(12) Patent Application Publication
(10) Pub. No.: US 2016/0098465 A1
(43) Pub. Date: Apr. 7, 2016

(54) METHOD, APPARATUS AND COMPUTER PROGRAM PRODUCT FOR PRESENTING COOKING SCHEDULE

(71) Applicant: National Tsing Hua University, Hsinchu City (TW)

(72) Inventors: Shan-Hung Wu, Hsinchu (TW); Ching-Chan Wu, Hsinchu (TW)

(21) Appl. No.: 14/844,002

(22) Filed: Sep. 3, 2015

(30) Foreign Application Priority Data
Oct. 7, 2014 (TW) 103134901

(51) Int. Cl. G06F 17/30

(52) U.S. Cl. CPC G06F 17/30554

(57) ABSTRACT

A method, an apparatus, and a computer program product for presenting a cooking schedule are provided. In the method, recipes are received, wherein each of the recipes includes cooking processes and cooking time required for finishing each of the cooking processes. The cooking processes are scheduled according to the cooking time of each of the cooking processes to make a total cooking time required for finishing all of the cooking processes in the recipes to be the shortest. Finally, the scheduled cooking processes are sequentially prompted.

### CROSS-REFERENCE TO RELATED APPLICATION

This application claims the priority benefit of Taiwan application serial no. 103134901, filed on Oct. 7, 2014. The entirety of the above-mentioned patent application is hereby incorporated by reference herein and made a part of this specification.

### BACKGROUND

1. Technical Field

The invention relates to a scheduling method and a scheduling apparatus, and particularly relates to a method and an apparatus for presenting cooking schedule.

2. Related Art

Conventional, when a cooking newbie learns to cook, he generally relies on paper recipe publications, and gradually finishes the cooking according to described steps of each dish. However, along with development of electronic apparatus and computer network, today's user can also download mobile applications (APP) related to cooking and recipes, and can be in collaboration with various recipe databases on network to display recipe pages on the electronic apparatus to assist learning cooking.

However, in the conventional technique, regardless of the paper recipe or electronic recipe, cooking processes of each dish are listed without considering a situation that a plurality of dishes are simultaneously cooked, which results in a fact that the user can only learn a single dish when learning cooking, and if a plurality of dishes are simultaneously cooked, the user has to arrange or assign cooking processes of different dishes by himself, which often causes confusion and the user cannot effectively finish a plurality of the dishes.

### SUMMARY

The invention is directed to a method, an apparatus and a computer program product for presenting cooking schedule, by which cooking processes of a plurality of recipes are broken up for rescheduling, so as to find a scheduling method of the shortest cooking time.

The invention provides a method for presenting cooking schedule, which is adapted to an electronic apparatus. In the method, a plurality of recipes is received, where each of the recipes includes a plurality of cooking processes and a cooking time required for finishing each of the cooking processes. Then, the cooking processes are scheduled according to the cooking time of each of the cooking processes to make a total cooking time required for finishing all of the cooking processes of the recipes to be the shortest. Finally, the scheduled cooking processes are sequentially prompted.

In an embodiment of the invention, the step of receiving the recipes includes following steps. A recipe database is accessed to display a recipe menu, and a selection operation performed on the recipe menu by a user is received to select the recipes.

In an embodiment of the invention, the cooking time includes a processing time required for manual execution of the user and a waiting time required for finishing the cooking process, and the step of scheduling the cooking processes according to the cooking time of each of the cooking processes to make the total cooking time required for finishing all of the cooking processes of the recipes to be the shortest includes a following step. The cooking processes are scheduled according to an appliance used in each of the cooking processes to make the total cooking time required for finishing all of the cooking processes of the recipes to be the shortest, where the processing time of the cooking processes are not overlapped with each other, and the cooking time of the cooking processes using the same appliance are not overlapped to each other.

In an embodiment of the invention, the step of sequentially prompting the scheduled cooking processes includes following steps. After an initial part of the prompted cooking process that is manually executed by the user is finished, a timing reminder of the waiting time of the cooking process is displayed. Moreover, when the waiting time is reached, the user is reminded to execute a remained part of the cooking process.

In an embodiment of the invention, the step of displaying the timing reminder of the waiting time of the cooking process further includes displaying the next cooking process required to be executed.

In an embodiment of the invention, the step of sequentially prompting the scheduled cooking processes includes following steps. The cooking process scheduled in the front is prompted. Moreover, when the cooking process is finished, the next cooking process required to be executed is prompted.

In an embodiment of the invention, the step of sequentially prompting the scheduled cooking processes further includes following steps. When the cooking process scheduled in the front is prompted, a finish operation performed to the cooking process by the user is received. The next cooking process required to be executed is prompted according to the finish operation.

The invention provides an apparatus for presenting cooking schedule including a prompt unit, a storage unit and a processing unit. The storage unit is used for recording a plurality of modules. The processing unit is coupled to the prompt unit and the storage unit, and is used for accessing and executing the modules recorded in the storage unit. The modules include a recipe receiving module, a cooking schedule module and a cooking prompt module. The recipe receiving module receives a plurality of recipes, where each of the recipes includes a plurality of cooking processes and a cooking time required for finishing each of the cooking processes. The cooking schedule module schedules the cooking processes according to the cooking time of each of the cooking processes to make a total cooking time required for finishing all of the cooking processes of the recipes to be the shortest. The cooking prompt module sequentially prompts the scheduled cooking processes on the prompt unit.

In an embodiment of the invention, the apparatus for presenting cooking schedule further includes an input unit. The input unit is coupled to the processing unit. The recipe receiving module accesses a recipe database and displays a recipe menu on the prompt unit, and uses the input unit to receive a selection operation performed on the recipe menu by a user, so as to select the recipes.

In an embodiment of the invention, the cooking time includes a processing time required for manual execution of the user and a waiting time required for finishing the cooking process, and the cooking schedule module schedules the cooking processes according to an appliance used in each of the cooking processes to make the total cooking time required for finishing all of the cooking processes of the recipes to be the shortest, where the processing time of the cooking processes are not overlapped with each other, and the cooking time of the cooking processes using the same appliance are not overlapped to each other.

In an embodiment of the invention, after an initial part of the prompted cooking process that is manually executed by the user is finished, the cooking prompt module displays a timing reminder of the waiting time of the cooking process on the prompt unit, and reminds the user to execute a remained part of the cooking process by using the prompt unit when the waiting time is reached.

In an embodiment of the invention, the cooking prompt module displays the next cooking process required to be executed on the prompt unit.

In an embodiment of the invention, the cooking prompt module prompts the cooking process scheduled in the front on the prompt unit, and prompts the next cooking process required to be executed on the prompt unit when the cooking process is finished.

In an embodiment of the invention, the apparatus for presenting cooking schedule further includes an input unit. The input unit is coupled to the processing unit. When the cooking prompt module prompts the cooking process scheduled in the front, the cooking prompt module receives a finish operation performed to the cooking process by the user by using the input unit, and prompts the next cooking process required to be executed on the prompt unit according to the finish operation.

The invention provides a computer program product, which is loaded to an electronic apparatus to execute following steps. A plurality of recipes is received, where each of the recipes includes a plurality of cooking processes and a cooking time required for finishing each of the cooking processes. Then, the cooking processes are scheduled according to the cooking time of each of the cooking processes to make a total cooking time required for finishing all of the cooking processes of the recipes to be the shortest. Finally, the scheduled cooking processes are sequentially prompted.

According to the above descriptions, in the method, the apparatus and the computer program product for presenting cooking schedule, the cooking processes in the recipes are scheduled into a step sequence with the shortest total cooking time according to the appliance used in each of the cooking processes and the waiting time required for finishing the cooking processes, so as to shorten the total cooking time required for processing a plurality of dishes. By sequentially prompting the scheduled cooking processes on the electronic apparatus, the user is guided to gradually finish the multiple dishes. In this way, the user is capable of correctly and quickly complete a plurality of dishes, so as to improve learning and practicing efficiency of cooking.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an apparatus for presenting cooking schedule according to an embodiment of the invention.

FIG. 2 is a flowchart illustrating a method for presenting cooking schedule according to an embodiment of the invention.

FIG. 3 is an example of a method for presenting cooking schedule according to an embodiment of the invention.

### DETAILED DESCRIPTION OF DISCLOSED EMBODIMENTS

During a cooking process, it is known that there are a plenty of idle times to wait for completion of cooking processes, for example, a time required for cooking rice by using an electric rice cooker, a time required for cooking soup by using a stockpot, or a time required for roasting meat by using an oven, etc., and the above time can all be used to perform cooking processes of other dishes. Therefore, according to the invention, under a situation of simultaneously processing a plurality of dishes, during the waiting time of each of the cooking processes, cooking processes of the other dishes are assigned, and the cooking processes using the same appliance are separated, so as to make a full use of the waiting time and reduce the total cooking time.

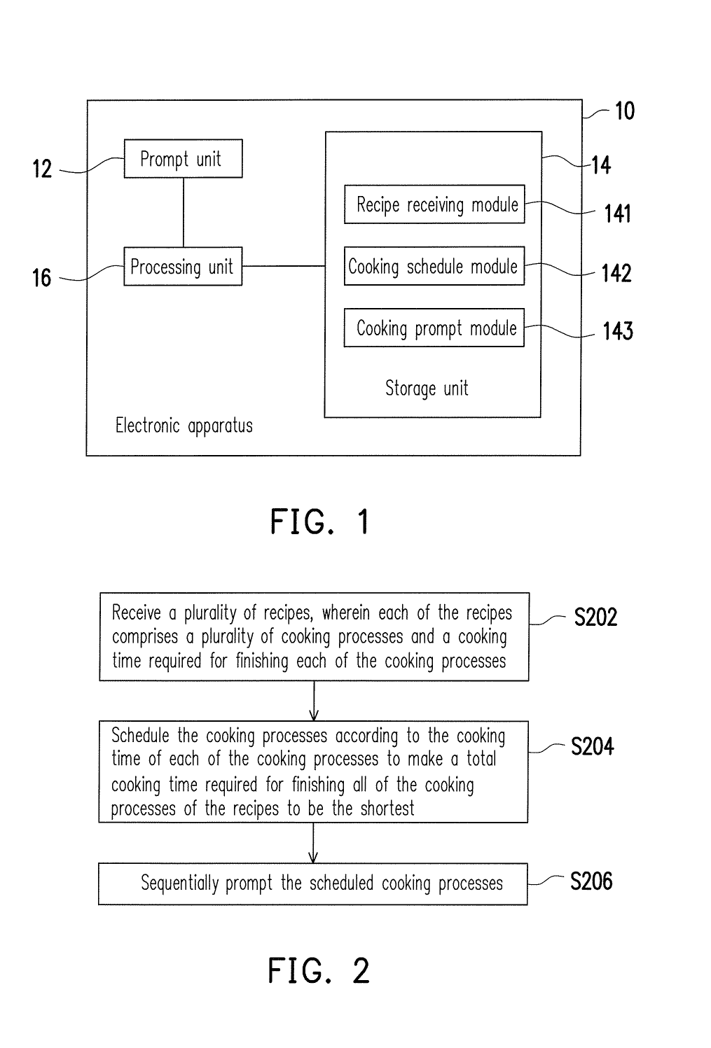

FIG. 1 is a block diagram of an apparatus for presenting cooking schedule according to an embodiment of the invention. Referring to FIG. 1, the electronic apparatus 10 of the present embodiment is, for example, a computer device such as a smart phone, a personal digital assistant (PDA), a PDA phone, a notebook computer, a tablet computer, or a smart television, etc., which includes a prompt unit 12, a storage unit 14 and a processing unit 16, and functions thereof are described below.

The prompt unit 12 is, for example, a speaker or audio equipment capable of outputting a sound prompt, or a liquid crystal display (LCD), a light-emitting diode (LED) display, a field emission display (FED) or displays using other panels that is capable of displaying prompts through images, which is not limited by the invention.

The storage unit 14 is, for example, any type of a fixed or movable random access memory (RAM), a read-only memory (ROM), a flash memory, a hard disk or other similar device or a combination of the above devices, which is used for recording a plurality of modules suitable for being executed by the processing unit 16, and the modules can be loaded to the processing unit 16 to execute a cooking schedule function.

The processing unit 16 is, for example, a central processing unit (CPU) having a single core or a plurality of cores, or other programmable general purpose or special purpose microprocessor, a digital signal processor (DSP), a programmable controller, an application specific integrated circuit (ASIC), a programmable logic device (PLD) or other similar device or a combination of the above devices. The processing unit 16 is respectively coupled to the prompt unit 12 and the storage unit 14, and is capable of accessing and executing the modules stored in the storage unit 14 to implement the cooking schedule function.

The above modules include a recipe receiving module 141, a cooking schedule module 142 and a cooking prompt module 143. These modules are, for example, computer programs, which can be loaded to the processing unit 16 to implement the cooking schedule function. Detailed steps for the electronic apparatus 10 executing the cooking schedule function are described below.

FIG. 2 is a flowchart illustrating a method for presenting cooking schedule according to an embodiment of the invention. Referring to FIG. 1 and FIG. 2, the method for presenting cooking schedule of the present embodiment is adapted to the electronic apparatus 10 of FIG. 1, and various steps of the method for presenting cooking schedule of the invention are described below with reference of various components of the electronic apparatus 10.

In step S202, the recipe receiving module 141 receives a plurality of recipes, where each of the recipes includes a plurality of cooking processes and a cooking time required for finishing each of the cooking processes. In detail, the recipe receiving module 141 can access a recipe database (not shown) stored in the storage unit 14 or a remote server. The recipe database includes a plurality of recipes recording the cooking processes and the cooking time, and the recipes are, for example, manually input by the user or collected from the Internet, which is not limited by the present embodiment. Moreover, the recipe receiving module 141 can access the recipes stored in the recipe database (not shown) and displays a recipe menu on the prompt unit 12, and uses an input unit (not shown) of the electronic apparatus 10 to receive a selection operation performed on the recipe menu by the user, so as to select the recipes. The input unit is, for example, a mouse, a touchpad, a touch panel having a resistive, capacitive or other types of touch sensing elements or a sensor capable of detecting any state variation, for example, a sound variation, a light variation, a brainwave variation or an environment variation, which can be combined with the prompt unit 12 to form a touch screen capable of displaying images, so as to receive the selection operation performed by the user to the recipe menu displayed on the prompt unit 12. It should be noticed that in another embodiment of the invention, the electronic apparatus 10 can also directly receive the recipes input by the user without accessing the recipe database, and the method of receiving the recipes is not limited by the invention.

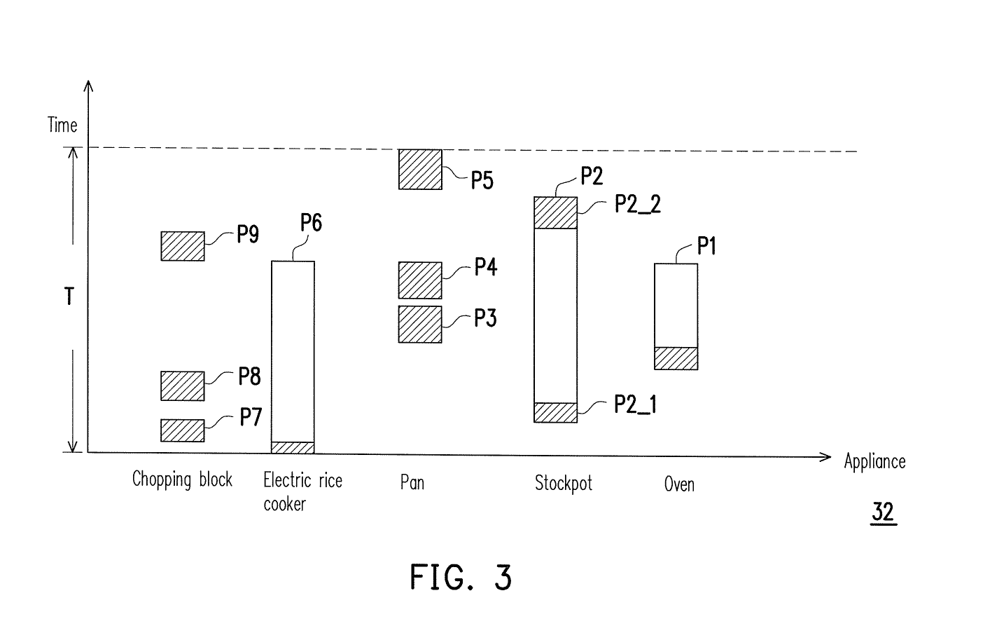

Then, in step S204, the cooking schedule module 142 schedules the cooking processes according to the cooking time of each of the cooking processes to make a total cooking time required for finishing all of the cooking processes of the recipes to be the shortest. For example, FIG. 3 is an example of a method for presenting cooking schedule according to an embodiment of the invention. Referring to FIG. 3, an X-axis of a distribution schematic diagram 32 represents all of appliances (including a chopping block, an electric rice cooker, a pan, a stockpot and an oven) required for the cooking processes, and a Y-axis represents time required for the cooking processes. In the present embodiment, the distribution schematic diagram 32 is a schedule result that the cooking schedule module 142 schedules cooking processes P1-P9 according to the appliances used in each of the cooking processes. The cooking time of each of the cooking processes is different, and includes a processing time (an oblique line section) required for manual execution of the user and a waiting time (a blank section) required for finishing the cooking process without an actual action of the user. The processing time (the oblique line sections) between the appliances that require the manual execution of the user are not overlapped with each other, and the cooking time of the cooking processes using the same appliance are not overlapped to each other (different parts of the same appliance represent different cooking processes). After the scheduling of the cooking schedule module 142, the total cooking time required for the user finishing all of the cooking processes P1-P9 in the recipes is the shortest, so as to effectively shorten the time required for cooking a plurality of dishes.

It should be noticed that in the aforementioned embodiment, although the scheduling is performed according to the appliances used by each of the cooking processes and the cooking manner thereof, the invention is not limited thereto. In other embodiments, the cooking processes can be scheduled according to other processing factors (for example, there are two gas stoves, three workers, two kitchens, or three pots, etc.) or different tasks (for example, stir-fry, to move between different equipment, to clean kitchenware, worker rest) in the cooking processes.

Referring back to the flow of FIG. 2, in step S206, the cooking prompt module 143 sequentially prompts the scheduled cooking processes on the prompt unit 12. In detail, the cooking prompt module 143 can prompt the cooking process scheduled in the front on the prompt unit 12 in a manner similar to path navigation of a navigation device, and when the current cooking process is finished, the cooking prompt module 143 prompts the next cooking process required to be executed on the prompt unit 12, and deduced by analogy until all of the cooking processes are finished. It should be noticed that during a process that the cooking prompt module 143 prompts the cooking process, an input unit (not shown) of the electronic apparatus 10 can be used to receive a finish operation performed to the cooking process by the user, or a change in environment or user status is detected to learn that the cooking process is finished. When it is learned that the cooking process is finished, the cooking prompt module 143 prompts the next cooking process required to be executed on the prompt unit 12.

In another embodiment, during a period of waiting for finish of the cooking process, the cooking prompt module can also display a timing reminder of the waiting time of the cooking process on the prompt unit such that the user can easily learn a finish time of the cooking process. In order to fully describe the step of sequentially prompt the scheduled cooking processes, details of sequentially prompting the cooking processes P1-P9 shown in FIG. 3 are described in detail with reference of FIG. 1 and FIG. 3.

Regarding the scheduled cooking processes P1-P9 shown in the distribution schematic diagram 32 of FIG. 3, the cooking prompt module 143 first prompts the cooking process P6 scheduled in the most front. The cooking process P6 is, for example, to use the electric rice cooker to cook rice, and after a short rice washing procedure, the cooking process P6 directly enters the waiting time required for finishing the rice cooking. At this time, the cooking prompt module 143 can display the timing reminder of the waiting time of the cooking process P6 on the prompt unit 12. Thereafter, the cooking prompt module 143 displays the next cooking process P7 required to be executed on the prompt unit 12.

It should be noticed that except for reminding the waiting time of the cooking process, the cooking prompt module 143 of the present embodiment can remind any measurement in the cooking process. For example, reminding of a quantity of heat exerted to a kitchenware, reminding of an amount of color change in cooked food ingredient or reminding of oil temperature, etc. In this way, the user is reminded to notice various statuses occurred during the cooking processes, so as to make necessary preparations.

Referring to FIG. 3, after the cooking prompt module 143 prompts the cooking process P7 scheduled in the front on the prompt unit 12, the cooking prompt module 143 prompts the next cooking process P2 required to be executed on the prompt unit 12 when the cooking process P7 is finished. The cooking process P2 is, for example, to use a stockpot to cook soup, such that after an initial part P2_1 (for example, pre-actions of adding soup materials, etc.) of the prompted cooking process P2 that is manually executed by the user is finished, the cooking prompt module 143 displays a timing reminder of the waiting time of the cooking process P2 on the prompt unit 12. Thereafter, the cooking prompting module 143 displays the next cooking process P8 required to be executed on the prompt unit 12.

Then, the cooking prompt module 143 prompts the cooking processes P8, P1, P3, P4, P9, P2_2, P5 in the same way. Moreover, after the waiting time of the cooking process P6 and the cooking process P1 is reached (ended), the cooking prompt module 143 prompts the user that the cooking process P6 and the cooking process P1 has finished through the prompt unit 12.

Moreover, when the waiting time of the cooking process P2 is reached (ended), the cooking prompt module 143 prompts the user to execute a remained part P2_2 (for example, a final seasoning action of soup cooking) of the cooking process P2 through the prompt unit 12, so as to remind the user to complete the remained step of the cooking process P2.

According to the above steps, by gradually prompting and reminding the user to perform the cooking processes, the time required for executing the cooking processes P1-P9 can be reduced to the shortest, so as to improve a cooking efficiency of the user.

It should be noticed that except for reducing the total cooking time to the shortest (the most time-saving) to implement scheduling the cooking processes, the other factors can also be used as a basis for scheduling the cooking processes according to user's demand. For example, the cooking processes can be scheduled according to a factor of making the amount of calorie of the user consumed during the cooking process to be the greatest, making the amount of gas consumed during the cooking process to be the lowest, or making the amount of water used for cleaning the cooking appliances or the food materials to be the lowest, etc.

The invention further provides a computer program product, which can be used to execute the method for presenting cooking schedule described above. The computer program is composed of a plurality of program instructions (for example, an organization chart establishing program instruction, a table approving program instruction, a setting program instruction, and a deployment program instruction, etc), and these program instructions are loaded into the electronic apparatus and executed by the same to accomplish various steps in the method for presenting cooking schedule described above.

In summary, in the method, the apparatus and the computer program product for presenting cooking schedule, when multiple dishes are required to be processed, the cooking processes in all of the recipes are separated by the manual execution part and the used appliances, so as to avoid manually executing a plurality of cooking processes or using the same appliance at a same time point. In this way, the waiting time required for each of the cooking processes can be fully used to shorten a total cooking time of the user when dealing with a plurality of dishes. Moreover, after the scheduling is finished, the scheduled cooking processes can be sequentially prompted on the electronic apparatus to guide the use to gradually complete the multiple dishes. In this way, the user is capable of correctly and quickly complete multiple dishes, so as to improve learning and practicing efficiency of cooking.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for presenting cooking schedule, adapted to an electronic apparatus, the method for presenting cooking schedule comprising:
receiving a plurality of recipes, wherein each of the recipes comprises a plurality of cooking processes and a cooking time required for finishing each of the cooking processes;
scheduling the cooking processes according to the cooking time of each of the cooking processes to make a total cooking time required for finishing all of the cooking processes of the recipes to be the shortest; and
sequentially prompting the scheduled cooking processes.

2. The method for presenting cooking schedule as claimed in claim 1, wherein the step of receiving the recipes comprises:
accessing a recipe database to display a recipe menu; and
receiving a selection operation performed on the recipe menu by a user to select the recipes.

3. The method for presenting cooking schedule as claimed in claim 1, wherein the cooking time comprises a processing time required for manual execution of a user and a waiting time required for finishing the cooking process, and the step of scheduling the cooking processes according to the cooking time of each of the cooking processes to make the total cooking time required for finishing all of the cooking processes of the recipes to be the shortest comprises:
scheduling the cooking processes according to an appliance used in each of the cooking processes to make the total cooking time required for finishing all of the cooking processes of the recipes to be the shortest, wherein the processing time of the cooking processes are not overlapped with each other, and the cooking time of the cooking processes using the same appliance are not overlapped to each other.

4. The method for presenting cooking schedule as claimed in claim 3, wherein the step of sequentially prompting the scheduled cooking processes comprises:
displaying a timing reminder of the waiting time of the cooking process after an initial part of the prompted cooking process that is manually executed by the user is finished; and
reminding the user to execute a remained part of the cooking process when the waiting time is reached.

5. The method for presenting cooking schedule as claimed in claim 4, wherein the step of displaying the timing reminder of the waiting time of the cooking process further comprises:
displaying the next cooking process required to be executed.

6. The method for presenting cooking schedule as claimed in claim 1, wherein the step of sequentially prompting the scheduled cooking processes comprises:
promoting the cooking process scheduled in the front; and
prompting the next cooking process required to be executed when the cooking process is finished.

7. The method for presenting cooking schedule as claimed in claim 6, wherein the step of sequentially prompting the scheduled cooking processes further comprises;
receiving a finish operation performed to the cooking process by a user when the cooking process scheduled in the front is prompted; and
prompting the next cooking process required to be executed according to the finish operation.

8. An apparatus for presenting cooking schedule, comprising:
a prompt unit;
a storage unit, recording a plurality of modules; and
a processing unit, coupled to the prompt unit and the storage unit, and accessing and executing the modules recorded in the storage unit, wherein the modules comprise:
a recipe receiving module, receiving a plurality of recipes, wherein each of the recipes comprises a plurality of cooking processes and a cooking time required for finishing each of the cooking processes;
a cooking schedule module, scheduling the cooking processes according to the cooking time of each of the cooking processes to make a total cooking time required for finishing all of the cooking processes of the recipes to be the shortest; and
a cooking prompt module, sequentially prompting the scheduled cooking processes on the prompt unit.

9. The apparatus for presenting cooking schedule as claimed in claim 8, further comprising an input unit coupled to the processing unit, wherein the recipe receiving module accesses a recipe database and displays a recipe menu on the prompt unit, and uses the input unit to receive a selection operation performed on the recipe menu by a user, so as to select the recipes.

10. The apparatus for presenting cooking schedule as claimed in claim 8, wherein the cooking time comprises a processing time required for manual execution of a user and a waiting time required for finishing the cooking process, and the cooking schedule module schedules the cooking processes according to an appliance used in each of the cooking processes to make the total cooking time required for finishing all of the cooking processes of the recipes to be the shortest, wherein the processing time of the cooking processes are not overlapped with each other, and the cooking time of the cooking processes using the same appliance are not overlapped to each other.

11. The apparatus for presenting cooking schedule as claimed in claim 10, wherein after an initial part of the prompted cooking process that is manually executed by the user is finished, the cooking prompt module displays a timing reminder of the waiting time of the cooking process on the prompt unit, and reminds the user to execute a remained part of the cooking process by using the prompt unit when the waiting time is reached.

12. The apparatus for presenting cooking schedule as claimed in claim 11, wherein the cooking prompt module displays the next cooking process required to be executed on the prompt unit.

13. The apparatus for presenting cooking schedule as claimed in claim 8, wherein the cooking prompt module prompts the cooking process scheduled in the front on the prompt unit, and prompts the next cooking process required to be executed on the prompt unit when the cooking process is finished.

14. The apparatus for presenting cooking schedule as claimed in claim 13, further comprising an input unit coupled to the processing unit, wherein when the cooking prompt module prompts the cooking process scheduled in the front, the cooking prompt module receives a finish operation performed to the cooking process by a user by using the input unit, and prompts the next cooking process required to be executed on the prompt unit according to the finish operation.

15. A computer program product, loaded to an electronic apparatus to execute following steps:
receiving a plurality of recipes, wherein each of the recipes comprises a plurality of cooking processes and a cooking time required for finishing each of the cooking processes;
scheduling the cooking processes according to the cooking time of each of the cooking processes to make a total cooking time required for finishing all of the cooking processes of the recipes to be the shortest; and
sequentially prompting the scheduled cooking processes.
